(19) United States
(12) Patent Application Publication
(10) Pub. No.: US 2015/0292206 A1
(43) Pub. Date: Oct. 15, 2015

(54) STACKABLE CONCRETE BLOCK AND METHOD FOR THE MANUFACTURING THEREOF

(71) Applicant: SCHEYS BETON, Lubbeek (BE)

(72) Inventor: Evrard Josef Frederickx, Aarschot (BE)

(73) Assignee: SCHEYS BETON, Lubbeek (BE)

(21) Appl. No.: 14/438,690

(22) PCT Filed: Oct. 31, 2013
(86) PCT No.: PCT/EP2013/072771

§ 371 Date: Apr. 27, 2015

(30) Foreign Application Priority Data
Oct. 31, 2012 (BE) 2012/0747

(51) Int. Cl. E04C 1/00; E02D 29/02; B28B 17/00

(52) U.S. Cl. CPC E04C 1/00; B28B 17/0009; E02D 29/025

(57) ABSTRACT

A concrete block, stackable into a wall, such as a retaining wall, with a upper side provided with at least two peaks and a bottom side provided with at least two recesses that are located right across from said peaks in such a way that the blocks, in brickwork bond, are stackable on top of each other. The concrete block is formed by a concrete base block with at least two continuous holes that connect the upper side of the base block with the bottom side thereof, and by at least two stones that fit at the top into the continuous holes to form the peaks of the concrete block. As no concrete peaks need to be provided on the base block itself, these base blocks can be pressed on a flat plate by means of a press in a simple and cheap manner.

The present invention concerns a stackable concrete block with an upper side provided with at least two peaks and a bottom side provided with at least two recesses that are located directly across from the aforesaid peaks. The concrete blocks are thereby in brickwork bond, in layers, stackable on top of each other, wherein the peaks on the upper side of a first layer of blocks are engaged in the recesses in the bottom side of the blocks of a second superimposed layer of blocks for mutually fixing both layers of blocks.

Such independently stackable blocks that can be made into a wall, are known from practice and, for example, are marketed under the name Masterbloc. These known blocks are solid, and therefore heavy, blocks that are manufactured in a mould. By means of such a mould it is possible to provide the concrete peaks and the recesses that are located directly across from the peaks. A disadvantage of such a moulding process is that the opening and closing of the moulds is a labour-intensive process and further, that with one mould only one block per day can be manufactured. The moulds are also relatively expensive and can only be used for one type of block. This method of production can therefore only be used for fairly large concrete blocks. The standard Masterbloc blocks have, for example, a size of 120×60×40 cm or of 150×75×40 cm.

A disadvantage of these blocks is that they are practically solid and therefore heavy and expensive and that they cannot be pressed, in contrast to the known hollow blocks. After all, using pressing it is not possible to provide corresponding recesses across from the peaks on the other side of the blocks. For in a press the blocks are manufactured on universally applicable flat plates on which the blocks are left to cure after pressing. It is possible to provide the blocks with holes and/or peaks on the upper side by means of a stamp, yet it is impossible to produce blocks that have, like the Masterbloc blocks, peaks on the upper side and that have, across from these peaks, recesses with the same shape as the peaks in such a way that the peaks fit into these recesses.

Hollow concrete blocks, pressed on a plate, for example, are known from EP 0 649 714. On these known blocks, a raised edge is pressed on the bottom side of the block, that extends along the front side of the block. On the bottom side of the blocks, an indentation is provided across from this raised edge by means of a slate, which can be pulled out of the mould. When stacking the blocks on top of each other, they are stacked with the indentation on the raised edge of the underlying block in such a way that the blocks will be fixed behind this raised edge. However, a disadvantage of these blocks is that the blocks can slide sideways and that these blocks in the longitudinal direction of the wall, in contrast to the Masterbloc blocks, are therefore not attached to each other, not even if they are stacked using a brickwork bond. Hence, this is disadvantageous to the cohesion/rigidness of the wall that is formed by the dry (hence, without mortar or glue) concrete blocks stacked on top of each other.

From U.S. Pat. No. 6,792,731 similar hollow concrete blocks are known that are, however, provided with attachment means for attaching anchoring nets to these concrete blocks. When building a retaining wall, these anchoring nets can be inserted in the ground behind the retaining wall to therefore firmly attach the retaining wall to the ground behind. However, the blocks themselves are still not laterally attached to each other and can therefore still laterally be pulled apart.

To avoid this, and to, at the same time, make the attachment of the anchoring nets possible, it is, for example, known from U.S. Pat. No. 4,914,876, U.S. Pat. No. 6,821,058 and US 2011/0243669 to apply between two layers of concrete block pins that extend from a pinhole in the upper side of a block into a corresponding pinhole in the bottom side of a block that is stacked on top of it. The used pins, for example, are manufactured from plastic and have only a limited thickness. Notwithstanding the possibility to make the pins somewhat conical, it is not simple to stack the concrete blocks, that are relatively heavy, correctly on top of each other and then to avoid damaging the thin pins. In some cases, the recess for the pins in the bottom side of the blocks is therefore formed larger. However, because of this, the concrete blocks can again be somewhat laterally shift relative to each other. In addition, the pins can therefore also not endure greater lateral tensile forces. An advantage of the use of thin pins is that it is still possible to provide, in addition to the pins, relatively big continuous holes to thus again obtain light, hollow blocks that are, however, in contrast, for example, to the heavy Masterbloc blocks, not as easily stackable and that also do not form such a rigid system.

A more robust version of the stackable blocks with on the top concrete peaks and on the bottom recesses for these peaks is known from U.S. Pat. No. 7,712,281. These known concrete blocks are pressed on a flat plate, where at the top at least one peak is formed out of the concrete of the block. In a first embodiment, the concrete top is located in the middle of the block and on the two sides of the block, each time a semi-continuous hole (a semi-circular hole) is provided such that, when two blocks are laterally placed against each other, a completely continuous hole through these blocks is formed. When these blocks are stacked on top of each other using a half brickwork bond, the peaks of a first layer of blocks is therefore engaging the bottom side of these continuous holes. Therefore, the blocks that are stacked on top of each other, cannot be shifted forwards or backwards relative to each other. However, laterally they are not attached to each other at all, such that the wall could be pulled apart in the longitudinal direction.

In a second embodiment of the blocks according to U.S. Pat. No. 7,712,281 they are provided with two peaks on their upper side. In the middle of these blocks between these two peaks, a continuous hole is provided, wherein further a continuous hole is formed again by two semi-continuous holes on the lateral ends of the blocks. Notwithstanding the fact that a number of blocks stacked into a wall (in a 1/3^{rd} brickwork bond) therefore cannot laterally shift anymore, relative to each other, the blocks form vertical arrays that are still not connected laterally. The wall is therefore still not resistant to tensile forces that are exerted on it in the longitudinal direction, which is detrimental to the rigidness of the wall. In this context, it is disclosed in U.S. Pat. No. 7,712,281 that, starting from a height of 90 to 120 cm, it is appropriate to provide additional continuous holes in the blocks to allow the application of steel tubes that can be entered vertically into the wall until they reach into the underlying ground. However, such tubes make the construction of the wall much more difficult and also constitute an import additional cost. Another disadvantage of the concrete blocks, known in this U.S. patent is that, although the blocks can be pressed, the size of the continuous holes is limited because these are each time located next to the peaks. It is therefore impossible to manufacture these blocks as light, and therefore as cheap, as the known hollow blocks that do not have peaks provided at the top, yet have to be fixed with pins.

This invention therefore aims to provide a new concrete block, which is provided, for example, like the Masterbloc blocks, on top with peaks and at the bottom with corresponding recesses in such a way that they can be stacked in relation to each other in order for the wall to withstand tensile forces, yet, in contrast to these Masterbloc blocks, can be pressed on flat plates.

To this end, therefore, the concrete block according to the invention is characterised that it is formed by a concrete base block, with at least two continuous holes that connect the upper side of the base block with the bottom side thereof, and that form said recesses in the bottom side of the block, and by at least two stones that fit at the top or bottom into said continuous holes and are provided to form said peaks.

Because peaks do not have to be provided anymore on the base block itself, but only the recesses for receiving the peaks, these base blocks can simply and inexpensively be pressed onto a flat plate, by means of a press. Furthermore, the continues holes can be made as large as desired, as the peaks are formed by the stones that are placed into these holes in such a way that, in contrast to the concrete blocks known from U.S. Pat. No. 7,712,281, adjacent to the continuous holes, no space needs to be provided for the peaks. Therefore, the blocks can be produced in a light and cheap fashion.

For shaping the peaks, stones are applied. In the present description, when mentioning stones, blocks of stones are meant, whereby the term “stone” should be understood as a hard substance with a mineral composition. Therefore, stone, for example, can be concrete, brick, natural stone or limestone. Optionally, the stones may including a reinforcement and may, for example, be made out of reinforced concrete.

The use of stones for shaping the peaks offers the advantage that such stones, in comparison to, for example, plastic materials or metal forms of the same size, are remarkably cheaper, as well as more rigid, and are more resistant to aging. In contrast to metals, stones, for example, do not rust and they show no signs of aging as do plastic materials. Since the stones are made out of the same mineral material as the concrete base blocks, they can easily be recycled, when destructed.

In a preferred embodiment of the concrete block according to the invention, the stones are manufactured from concrete.

Therefore, manufacturing of these stones can also be done in a simple and cheap manner, especially by pressing these stones out of concrete into the desired shape, on a flat plate.

In a further preferred embodiment of the concrete block according to the invention, the continuous holes have a smallest diameter that is larger than 3 cm, preferably larger than 5 cm and more preferably larger than 7 cm.

As the stones fit into these holes, they have matching dimensions and they are therefore of considerable size. In this manner, they can absorb large shear forces between the different layers of blocks. Also, their upper and lower ends can be considerably bevelled in such a way that the different blocks, by the obtained centering effect, can easily be placed on top of each other.

In an preferred embodiment of the concrete block according to the invention, the base blocks are provided to be attached to concrete, preferably tube-shaped anchoring blocks, wherein said base blocks and said anchoring blocks are provided with interengageable connection means for attaching said anchoring blocks to the base blocks and wherein said connection means preferably form a dove-tail joint.

When the concrete block is used for the construction of retaining walls, these anchoring blocks can simply be attached to the rear side of the concrete blocks. After the filling of these anchoring blocks with, for example, a fine or coarse aggregate, these anchoring blocks provide a secure anchoring of the retaining wall into the ground behind, without the need for anchoring nets. Such anchoring nets are not easy to install in the correct way (as they, for example, have to be properly tensioned) and further require complex fastening systems in the concrete blocks, even more so with the presence of the peaks, that make the manufacturing of the blocks more difficult (and may lead to more waste blocks).

The invention further relates to a set of stones and to a base block for composing a concrete block according to the invention and to a method for manufacturing such a concrete block wherein at least the base block is pressed out of concrete by means of a press on a flat plate.

Finally, the invention also relates to a wall, especially a ground retaining wall, which is made with concrete blocks according to the invention, in particular by dry (i.e., without adhesives) stacking the concrete blocks in layers using a brickwork bond.

Other advantages and particularities of the invention will become apparent from the following description of a preferred embodiment of a concrete block according to the invention. However, this description is only given as an example and is not meant to limit the scope of protection as defined by the claims. The reference numbers as indicated in the description relate to the accompanying drawings wherein:

FIG. 1 is a perspective view on a concrete base block of a concrete block according to the first embodiment of the invention;

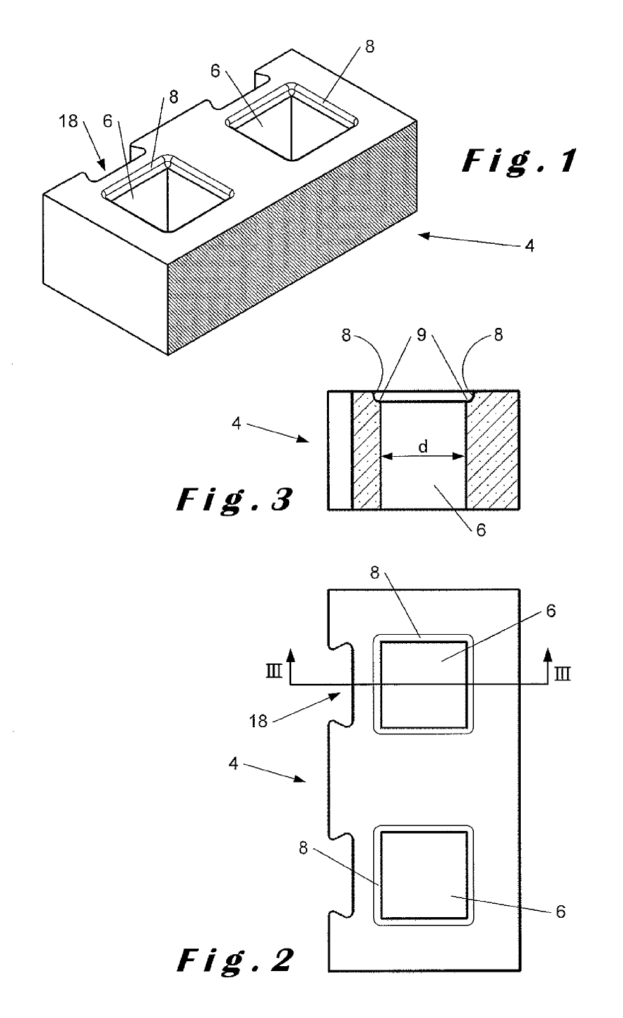

FIG. 2 is a plan view of the base block shown in FIG. 1;

FIG. 3 is a cross-section through the base block according to line III-III in FIG. 2;

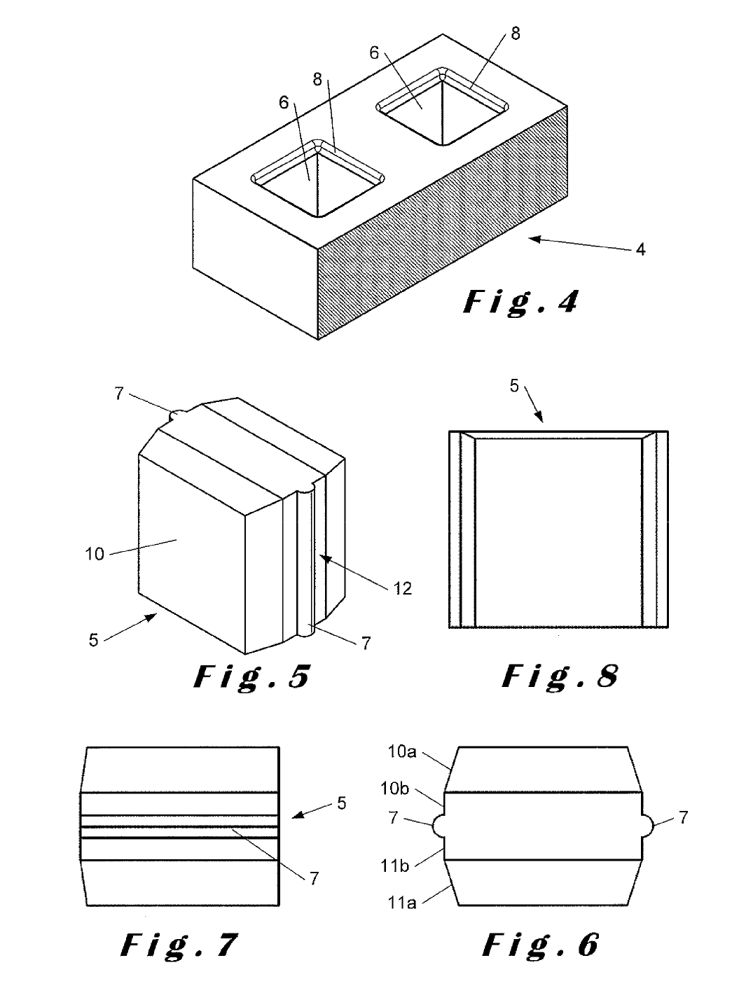

FIG. 4 is a perspective view on a base block according to a variant embodiment;

FIG. 5 is a perspective view on a stone that fits into the continuous holes of the base blocks according to the previous figures;

FIGS. 6 to 8 are respectively a top view, a front view, and a side view on the stone shown in FIG. 5;

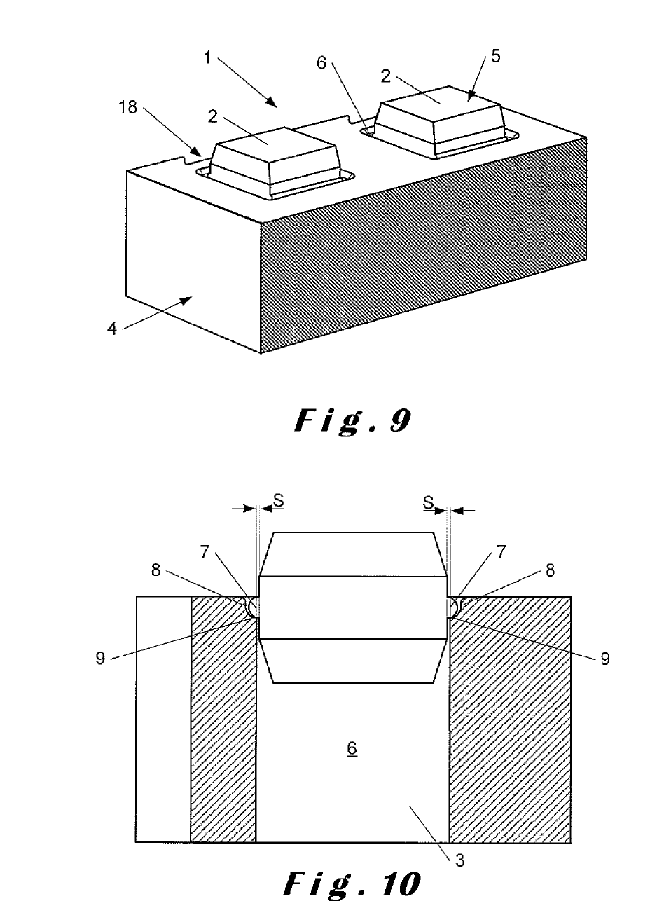

FIG. 9 is a perspective view on a concrete block composed of the base block according to FIG. 1 and of two stones according to FIG. 5;

FIG. 10 is a cross-sectional view through the concrete block shown in FIG. 9 at the position of one of the continuous holes therein.

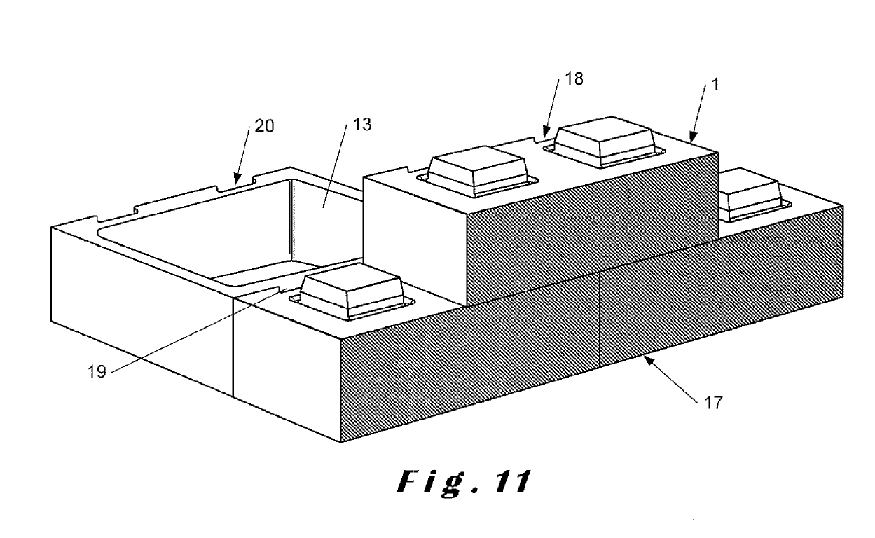

FIG. 11 is a perspective view on a section of a retaining wall obtained by stacking a number of concrete blocks on top of each other according to FIG. 9 and by hooking an anchoring block behind it;

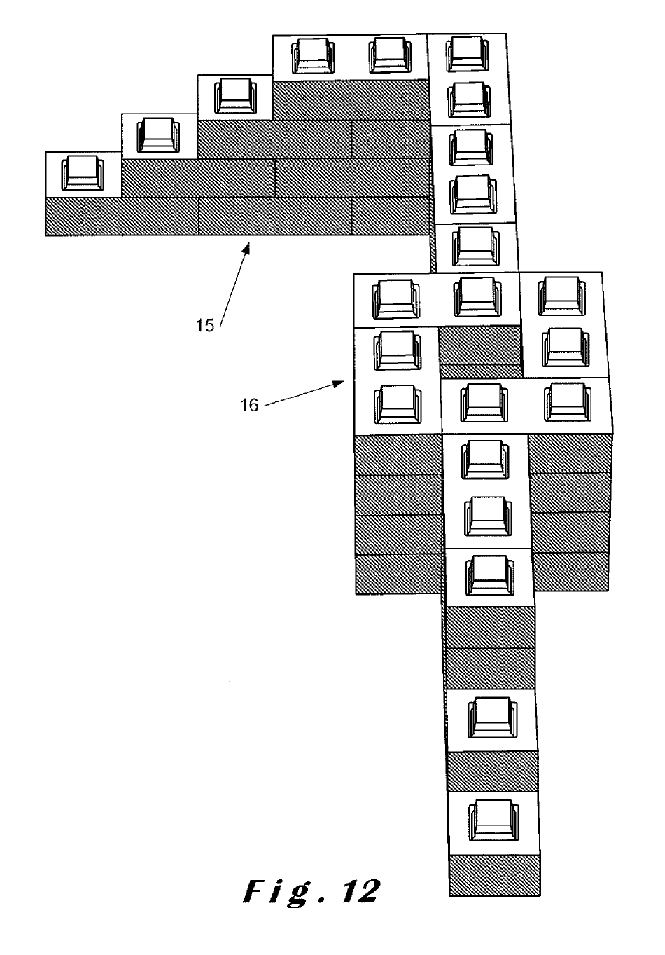

FIG. 12 is a perspective view on a section of a wall obtained by stacking, using a brickwork bond, a number of concrete blocks with base blocks according to FIG. 4 on top of each other;

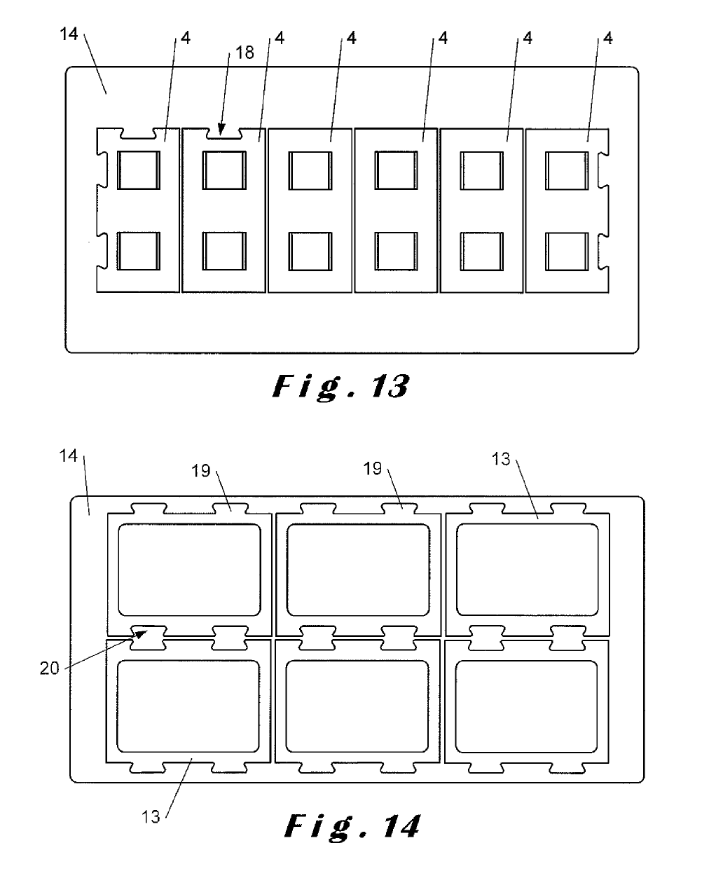

FIG. 13 is a top view on a flat plate on which a number of different base blocks are pressed; and

FIG. 14 is a top view on a flat plate on which a number of anchoring blocks are pressed.

The invention generally relates to a concrete block 1 with an upper side provided with at least two peaks 2 and a bottom side with at least two recesses 3 that are located right across from the peaks 2. The peaks 2 and the recesses 3 are mounted in such a way that a number of these concrete blocks 1 can stacked onto each other such that they form a wall. Here, the peaks 2 on the upper side of a layer of blocks fit into the recesses 3 in the bottom side of the layer of blocks 1 that is superimposed thereon, such that both layers of blocks are mutually fixed or, with other words, in such a way that there is no or virtually no mutual displacement possible of the blocks that are stacked on top of each other.

The concrete block 1 according to the invention is formed by a concrete base block 4 and by at least two stones 5. The base block 4 itself exhibits at least two continuous holes 6 that extend from the upper side of the base block 4 to its bottom side and that form the above described recesses 3 in the bottom side of the concrete block 1. As is clearly visible in FIG. 9, the stones 5 are provided to be mounted at the top in the continuous holes 6. The stones 5 hereby protrude out above the upper side of the base block 4 and therefore form the protruding peaks 2 of the concrete block 1. An important advantage of the composition of the concrete blocks 1 from base blocks 4 and from stones 5 is that, because of this, the base blocks 4, and preferably the stones 5 as well, can be pressed on a flat plate by means of a press, which is considerably cheaper than when the concrete blocks have to be manufactured in a specific shape.

The stones 5 fit both into the upper side as well as in the bottom side of the continuous holes 6. Preferably, there is some clearance S between the stones 5 and the inner side of the continuous holes 6. In this way, the stones 5 can be mounted into the holes 6 without difficulty. The total clearance, which is to say, the total distance over which the stones 5 can move in each lateral direction in the continuous holes 6 (=2S), is, however, preferably at most 10 mm, more preferably at most 6 mm, and most preferably at most 3 mm. In this way, only a minimal mutual displacement of the concrete blocks 1 that are stacked on top of each other is possible.

The stones 5 can be manufactured from different stone materials. For example, they can be manufactured from concrete or natural stone (for example from smaller natural stone waste). However, preferably, they are manufactured from concrete like the base blocks 4 themselves.

The height of the stones 5 could possibly be equal to the height of the base blocks 4, but in order to save material, the stones preferably have a smaller height. In order to avoid that the stones 5 fall too far into the continuous holes 6, without the need to partly fill these holes, the stones 5 preferably have a thickening 7 with which may rest on the upper side of the base block 4. As is clearly visible in FIG. 5, this thickening 7 can also be formed by a protruding edge, that is, for example, semi-circular in cross-sectional view. This edge can extend completely around the stone, but is preferably only provided at two sides that are right across from each other. When the stones 7 are made out of concrete, these can be made in this manner by means of the usual presses which, for example, are used for pressing bricks or concrete blocks, on a flat plate. In FIGS. 7 and 8 it can be seen that the stones 6, used in the embodiment, shown in the different figures, have one flat side with which they can be pressed onto a flat plate.

To avoid that the blocks that are stacked on top of each other are held at a distance from each other by the thickening 7 of the stones 5, these thickenings have to be held, either at the bottom or at the top, in the holes 6. As is clearly visible in FIG. 3 these holes 6 thereto display a widening 8 at the bottom or upper side, preferably upper side, of the base blocks 4.

This widening may, for example, be formed by the fact that the continuous holes are conical, whereby the base blocks 4, for example, with the biggest openings of their continuous holes 6, may be oriented face downwards in such a way that the stones 5 with their thickening 7 keep resting on the upper side of the base block.

As shown in FIGS. 5 to 8, the stones 5 preferably contain an upper section 10 that is provided to fit into the continuous holes 6 at the bottom, a bottom section 11 that is provided to fit into the continuous holes 6 at the top and a middle section 12 that is located between the upper section 10 and the bottom section 11 and which forms the thickening 7 of the stones 5. To obtain a centering effect by stacking the concrete blocks 1 on top of each other, and with the application of the stones 5 in the continuous holes 6, the upper section 10 and the bottom section 11 of the stones 5 display a bevelled end 10a and 11a. In the figures these ends are only bevelled on three sides as the stones are pressed on a flat plate with one side and are therefore completely flat on that side.

In order to obtain a firm fixation between the stacked concrete blocks 1, and to keep the clearance between the stones 5 and the inner side of the continuous holes 6 under control, the upper section 10 and bottom section 11 of the stones 5 display, between their thickening 7 and their bevelled ends 10a and 11a, a substantially straight section 10b and 11b with which the stones 5 fit into the continuous holes 6, with the above described clearance.

The continuous holes 6 preferably have a smallest diameter d, measured in a plane, parallel to the upper or lower side of the base block 4, that is larger than 3 cm, preferably larger than 5 cm, and more preferably larger than 7 cm. Because the stones 5 fit into these continuous holes, these have a corresponding dimension, and therefore have a minimal thickness, in such a way that they can provide a firm connection between the blocks. In comparison to, for example, metal or plastic pins, stones after all tend to have a smaller tensile or breaking strength. However, because they are inserted in concrete blocks according to the invention in the relatively big continuous holes, to form the relatively large peaks on top of the concrete blocks, they can be formed in a large way. The cost of these stones also remains limited because they can be manufactured out of stone, particularly out of concrete, which is very durable but still cheaper than metal or plastic material.

In FIG. 13, a flat plate 14 is shown on which a number of different concrete blocks 14 have been pressed. This pressing happens by means of a so-called earth-moist concrete which makes sure that the blocks immediately maintain their shape in such a way that immediately after the pressing, the mould can be removed and the blocks can be left behind on the flat plate 14 in order to harden further. The base blocks are therefore manufactured using a pressing process involving immediate demoulding.

The concrete blocks 1 that are shown in the figures have two peaks 2 at the top and two corresponding recesses 3 (formed by the continuous holes 6), that are located right across each other, in such a way that with these concrete blocks 1, with a half brickwork bond, a rigid wall 1 of dry stacked blocks can easily be obtained. Such a wall 15 is shown in FIG. 12, wherein in that wall 15 a thicker pole 16 is formed with those blocks. Due to the peaks 12, and the connection with which the blocks are stacked on top of each other, the blocks are also firmly connected in the longitudinal direction of the wall.

It will be obvious in the concrete blocks according to the invention that more than two continuous holes 6 (and therefore peaks 2) can be provided, for example, two rows of two, three, four or more continuous holes 6, and that these blocks can then be stacked on top of each other in all sorts of different brickwork bonds. Where the blocks displayed in the figures can be approximately 40×20×12,5 cm in size, such multiple peak concrete blocks may be considerably larger, wherein due to the system of continuous holes each time an important weight decrease can be obtained. However, since the blocks can be pressed, also the smaller blocks can be produced in large quantities in an economically responsible manner.

It is also possible with the concrete blocks according to the invention to not only form normal walls 15, as shown in FIG. 12, but also to make ground retaining walls 17 of which, for example, a small section is shown in FIG. 11. In the normal wall according to FIG. 12 use is made of concrete blocks obtained starting from a base block 4 as shown in FIG. 4. This base block 4 has a front and a rear side, as well as two end surfaces, that are meant to form an exposed side of the wall 15. In contrast to a normal wall 15, retaining walls 17 have a rear side that does not remain visible and that is meant to be anchored to the underlying ground. For the creation of such a retaining wall 17 in FIG. 11 use is made of concrete blocks that are shown in FIG. 9 and are obtained starting from a base block 4 according to FIG. 1.

In these base blocks 4, connection means are provided in the rear side for the attachment of concrete anchoring blocks 13. The connection means are formed by two straight, vertical grooves 18 of which the sides form an undercut. Because of this, the grooves 18 form more particularly a cross-sectional dovetail-shaped space. Of the anchoring blocks 13, only one is shown in FIG. 11. This anchoring block 13 is completely hollow and is tube-shaped (with a tube length that corresponds with the height of the base block 4). For the attachment of the anchoring blocks 13 to the base blocks 4, the anchoring blocks are provided with straight, vertical, raised edges 19 on the front side that, in cross-section, have a shape that is complementary to the space in the grooves 18. In a cross-section view, these raised edges are therefore also dovetail-shaped. Due to the complementary form, the anchoring blocks 13 can be shoved with the raised edges 19 into the grooves 18 of the base blocks 14 so as to, through a dove-tail joint, get fixed to these base blocks 14.

In the concrete blocks, used in the retaining wall, according to FIG. 11, only the rear sides of the grooves 18 are provided. However, as is apparent from FIG. 13, it is also possible to provide these grooves 18, or at least one of them, at a end of the base block 4. Furthermore, it is possible to provide grooves 18 on both the rear side as well as the

ends of these base blocks 4. In this manner, it becomes possible, for example, to form a rectangle with the retaining wall, wherein then the crosscut end of that retaining wall can also be anchored by means of anchoring blocks 13.

The tube-shaped anchoring blocks 13 are preferably also on their rear side provided with two grooves 20 that are identical to the grooves 18 in the rear side of the base blocks 4. Because of this, multiple anchoring blocks 13 can be coupled to each other, dependent on the height of the retaining wall or, with other words, of the required anchoring of the retaining wall in the underlying ground. Due to the open shape of the anchoring block 13, these can easily be filled with a fine or coarse granulate, whereby this granulate not only ensures that the required weight is met, but also ensures that possible egress of ground water is quickly drained, which ensures that there will be no hydrostatic pressure on the retaining wall and thereby further successive freeze and thaw cycles will have less effect on the retaining wall.

In the same way as the base blocks 4, the tube-shaped anchoring blocks 13 can also be pressed out on flat plates. For this purpose, the same plates and the same presses can be used, wherein solely the press mould needs to be changed. FIG. 14 shows a range of concrete anchoring blocks 13 that were pressed on a flat plate.

It will be clear that all sorts of amendments can be made to the above described concrete blocks and anchoring blocks without going outside of the scope of protection of the claims. In particular, it is possible to replace the grooves in the base blocks with raised edges, as the ones that are provided on the anchoring blocks, wherein for the anchoring of the retaining wall, the anchoring blocks then have to be turned around.

1-17. (canceled)

18. A concrete block with a upper side provided with at least two peaks and a bottom side provided with at least two recesses that are located right across from said peaks in such a way that a plurality of said concrete blocks, in brickwork bond, in layers, are stackable on top of each other, wherein the peaks on the upper side of a first layer of concrete blocks are engaged in the recesses in the bottom side of the concrete blocks of a second superimposed layer of concrete blocks for mutually fixing both layers of concrete blocks;
wherein said concrete block is formed by a concrete base block, with at least two continuous holes that connect the upper side of the base block with the bottom side thereof and which form said recesses in the bottom side of the concrete block, and by at least two stones that fit into said continuous holes that are located at the top and the bottom and that are provided to form said peaks.

19. The concrete block according to claim 18, wherein said stones are made of concrete.

20. The concrete bock according to claim 18, wherein said stones have a thickening with which these stones, when they are placed on top of a base block in one of the continuous holes thereof, rest on the upper side of this base block.

21. The concrete block according to claim 20, wherein said continuous holes connecting the upper side of the base block with the bottom side thereof have a widening for holding the thickening of said stones.

22. The concrete block according to claim 21, wherein said widening of said continuous holes forms a recess in the upper side of said base block.

23. The concrete block according to claim 22, wherein said recesses in said continuous holes form a shoulder, wherein said stones are provided to rest with their thickening on said shoulders.

24. The concrete block according to claim 23, wherein said stones contain an upper section that is provided to fit in the bottom of said continuous hole, a bottom section that is provided to fit in the top of said continuous hole and a middle section that is located between the upper and the bottom section and that forms the thickening of said stones.

25. The concrete block according to claim 24, wherein said upper and bottom sections of said stones display a bevelled end.

26. The concrete block according to claim 25, wherein said upper and lower sections of said stones, display, between their thickening and their bevelled ends, a substantially straight section with which the stones fit into said continuous holes.

27. The concrete block according to claim 18, wherein said stones fit in said continuous holes with a total clearance of at most 10 mm.

28. The concrete block according to claim 18, wherein said holes have a smallest diameter that is larger than 3 cm.

29. The concrete block according to claim 18, wherein said base blocks are provided to be attached to concrete, by tube-shaped anchoring blocks, wherein said base blocks and said anchoring blocks are provided with interengageable connection means for attaching said anchoring blocks to the base blocks and wherein said connection means form a dovetail joint.

30. The concrete block according to claim 18, wherein said base blocks are pressed out of concrete using a pressing process involving immediate demoulding.

31. A set of stones and of a base block for composing a concrete block according to claim 18.

32. A method for producing a concrete block according to claim 18, comprising the step of pressing said basic block from concrete by means of a press on a flat plate.

33. The method according to claim 32, wherein said base block is nearly immediately removed from the press after pressing.

34. A wall, in particular a retaining wall, manufactured with concrete blocks according to claim 18.
